(19) United States
(12) Patent Application Publication
(10) Pub. No.: US 2017/0138561 A1
(43) Pub. Date: May 18, 2017

(54) LIGHTING FIXTURE WITH POLYMER-BASED FRAME AND METHODS OF FORMING THE SAME

(71) Applicant: 3FORM, LLC, Salt Lake City, UT (US)

(72) Inventor: Nicholas Van Strander, Shoreline, WA (US)

(73) Assignee: 3Form, LLC, Salt Lake City, UT (US)

(21) Appl. No.: 14/767,890

(22) PCT Filed: May 28, 2015
(86) PCT No.: PCT/US15/33014

§ 371 Date: Aug. 13, 2015

Related U.S. Application Data
(60) Provisional application No. 62/004,081, filed on May 28, 2014.

(51) Int. Cl. F21V 1/22; F21V 17/08; F21S 8/06

(52) U.S. Cl. CPC F21V 1/22; F21S 8/06; F21V 17/08; F21W 2121/00

(57) ABSTRACT

Lighting fixtures providing light-weight construction and displaying reduced visibility of underlying support elements. The lighting fixtures include a non-opaque, polymer-based frame that provides structure without producing a substantial shadow on the outer display surface thereof when illuminated from the inside. The frame is attached to and extends from a rigid support element, and a lighting element disposed between the support element and the display surface reduces a shadow of the support element from being cast on the display surface. The frame can wrap around and conceal the support element from a first vantage point. The lighting fixture can also be decorated with one or more design elements connected to the display surface of the frame. The lighting fixture can be produced by thermoforming a polymeric substrate into a three-dimensional structural frame and connecting the frame at one end to the support element.

### CROSS-REFERENCE TO RELATED APPLICATIONS

The present application is a 371 U.S. National Stage of PCT Application No. PCT/US2015/033014, filed May 28, 2015 entitled “LIGHTING FIXTURE WITH POLYMER-BASED FRAME ELEMENT AND METHODS OF FORMING THE SAME,” which claims the benefit of priority to the U.S. Provisional Application No. 62/004,081, filed May 28, 2014, entitled “LIGHTING FIXTURE WITH POLYMER-BASED FRAME ELEMENT AND METHODS OF FORMING THE SAME”. The entire content of the above-mentioned patent applications are incorporated in their entirety herein by reference.

### BACKGROUND OF THE INVENTION

1. Technical Field

The present disclosure relates to systems, methods and apparatus for providing illumination.

2. Related Technology

Recent trends in building design involve using one or more sets of decorative panels to add to the functional and/or aesthetic characteristics of a given structure or design space. In particular, the use of resin or polymer-based panels is becoming increasingly popular in lighting applications. Such polymeric materials may be manufactured to be more resilient and to have a similar transparent, translucent, or decorative appearance as cast or laminated glass, but with less cost. In addition, resin-based materials tend to be more flexible and versatile in terms of manufacture and assembly as they can be relatively easily thermoformed, bent, molded, colored, textured, shaped, gauged, cut, and otherwise modified in a variety of different ways and can provide a larger variety of colors, images, interlayers, shapes, and impact resistance than can glass.

Certain polymer-based lighting applications involve wrapping an aluminum or other-metal frame with resin material to form a base structure to which aesthetic design elements can be attached. A metal frame provides a support structure for the polymer covering, an attachment point for suspending or supporting hardware, and allows for the coupling of multiple smaller lighting modules to form a larger modular lighting assembly. However, such lighting systems can be heavy and cumbersome; requiring machinery and/or skilled personnel to install, assemble, move, and disassemble.

Another drawback to such lighting systems includes shadows, dark spots, and/or other unsightly byproducts or consequences of the design, manufacturing, and/or assembling processes. In particular, the metal frame element(s) cast aesthetically unappealing shadows through the translucent or transparent polymeric covering and design features. Shadows of this sort may detract from the aesthetic appeal of the lighting element. Previous attempts to reduce or eliminate such shadows involved the use of diffuser materials and manufacturing design arrangements to hide the metal under-structure from view. Such attempted solutions are both expensive and complex.

Accordingly, there are a number of disadvantages in polymer-based lighting fixtures that can be addressed.

### BRIEF SUMMARY OF THE INVENTION

Implementations of the present disclosure solve one or more of the foregoing or other problems in the art with systems, methods, and apparatus for improved light fixtures, as well as components and/or sub-components thereof. In particular, implementations of the present disclosure relate to lighting fixtures having a polymer-based frame or structural element. For example, one or more implementations of the present disclosure include systems, methods, and apparatus for a lighting fixture having a light-weight, polymer-based frame element attached to a metal support or structural component. In certain implementations, the lighting fixture is substantially free of underlying metal frame elements capable of casting or otherwise producing a shadow on or through a body portion or display surface of the polymer-based frame element. In at least one implementation, the polymer-based frame element extends from the metal support or structural component such that the body portion of the polymer-based frame element is substantially free of an underlying metal frame or support structure.

Additional features and advantages of exemplary implementations of the present disclosure will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the implementations briefly described above will be rendered by reference to specific implementations and/or embodiments thereof which are illustrated in the appended drawings. For better understanding, the like elements have been designated by like reference numbers throughout the various accompanying figures. Understanding that these drawings depict only typical implementations and/or embodiments of the invention and are not therefore to be considered to be limiting of its scope, the invention will be described and explained with additional specificity and detail through the use of the accompanying drawings in which:

FIG. 1 illustrates a top perspective view of a lighting fixture in accordance with an implementation of the present disclosure;

FIG. 2 illustrates an exploded view of the lighting fixture of FIG. 1.

FIG. 3 illustrates a top plan view of a polymer-based frame element useful in forming the lighting fixture of FIG. 1 in an unfolded configuration;

FIG. 4 illustrates a perspective view of the polymer-based frame element of FIG. 3 in a partially folded configuration;

FIG. 5 illustrates a top plan view of a polymer-based frame element in an unfolded configuration in accordance with an implementation of the present disclosure;

FIG. 6 illustrates a top perspective view of the polymer-based frame element of FIG. 5 in a first folded configuration with a corresponding frame support element;

FIG. 7 illustrates a top perspective view of the polymer-based frame element of FIG. 5 in a second folded configuration with a corresponding frame support element;

FIG. 8 illustrates a top perspective view of the polymer-based frame element of FIG. 5 in a third folded configuration with a corresponding frame support element;

FIG. 9 illustrates a top perspective view of a polymer-based frame element in an unfolded configuration in accordance with another implementation of the present disclosure;

FIG. 9A illustrates a top perspective view of the polymer-based frame element of FIG. 9 in a folded configuration with a corresponding frame support element; and

FIG. 10 illustrates a top perspective view of a lighting fixture in accordance with another implementation of the present disclosure.

### DETAILED DESCRIPTION OF THE PREFERRED EMBODIMENTS

Before describing the present disclosure in detail, it is to be understood that this disclosure is not limited to the specific parameters of the particularly exemplified systems, methods, apparatus, assemblies, products, processes, and/or kits, which may, of course, vary. It is also to be understood that the much, if not all of the terminology used herein is only for the purpose of describing particular implementations of the present disclosure, and is not necessarily intended to limit the scope of the disclosure in any manner. Thus, while the present disclosure will be described in detail with reference to specific configurations, the descriptions are illustrative only and are not to be construed as limiting the scope of the claimed invention. Various modifications can be made to the illustrated configurations without departing from the spirit and scope of the invention as defined by the claims. Thus, while various aspects and implementations have been disclosed herein, other aspects and implementations are contemplated.

Unless defined otherwise, all technical and scientific terms used herein have the same meaning as commonly understood by one of ordinary skill in the art to which the present disclosure pertains. While a number of methods and materials similar or equivalent to those described herein can be used in the practice of the present disclosure, only certain exemplary materials and methods are described herein.

Various aspects of the present disclosure, including devices, systems, kits, methods, etc., may be illustrated with reference to one or more exemplary embodiments or implementations. As used herein, the terms “exemplary embodiment” and/or “exemplary implementation” means “serving as an example, instance, or illustration,” and should not necessarily be construed as preferred or advantageous over other embodiments or implementations disclosed herein. In addition, reference to an “implementation” of the present disclosure or invention includes a specific reference to one or more embodiments thereof, and vice versa, and is intended to provide illustrative examples without limiting the scope of the invention, which is indicated by the appended claims rather than by the following description.

It will be noted that, as used in this specification and the appended claims, the singular forms “a,” “an” and “the” include plural referents unless the content clearly dictates otherwise. Thus, for example, reference to a “line” includes one, two, or more lines. Similarly, reference to a plurality of referents should be interpreted as comprising a single referent and/or a plurality of referents unless the content and/or context clearly dictate otherwise. Thus, reference to “lines” does not necessarily require a plurality of such lines. Instead, it will be appreciated that independent of conjugation; one or more lines are contemplated herein.

As used throughout this application the words “can” and “may” are used in a permissive sense (i.e., meaning having the potential to), rather than the mandatory sense (i.e., meaning must). Additionally, the terms “including,” “having,” “involving,” “containing,” “characterized by,” variants thereof (e.g., “includes,” “has,” and “involves,” “contains,” etc.), and similar terms as used herein, including the claims, shall be inclusive and/or open-ended, shall have the same meaning as the word “comprising” and variants thereof (e.g., “comprise” and “comprises”), and do not exclude additional, un-recited elements or method steps, illustratively.

Various aspects of the present disclosure can be illustrated by describing components that are coupled, attached, connected, and/or joined together. As used herein, the terms “coupled”, “attached”, “connected,” and/or “joined” are used to indicate either a direct connection between two components or, where appropriate, an indirect connection to one another through intervening or intermediate components. In contrast, when a component is referred to as being “directly coupled”, “directly attached”, “directly connected,” and/or “directly joined” to another component, no intervening elements are present or contemplated. Thus, as used herein, the terms “connection,” “connected,” and the like do not necessarily imply direct contact between the two or more elements. In addition, components that are coupled, attached, connected, and/or joined together are not necessarily (reversibly or permanently) secured to one another. For instance, coupling, attaching, connecting, and/or joining can comprise placing, positioning, and/or disposing the components together or otherwise adjacent in some implementations.

It will also be appreciated that where a range of values (e.g., less than, greater than, at least, and/or up to a certain value, and/or between two recited values) is disclosed or recited, any specific value or range of values falling within the disclosed range of values is likewise disclosed and contemplated herein. Thus, disclosure of an illustrative measurement or distance less than or equal to about 10 units or between 0 and 10 units includes, illustratively, a specific disclosure of: (i) a measurement of 9 units, 5 units, 1 units, or any other value between 0 and 10 units, including 0 units and/or 10 units; and/or (ii) a measurement between 9 units and 1 units, between 8 units and 2 units, between 6 units and 4 units, and/or any other range of values between 0 and 10 units.

As used herein, directional and/or arbitrary terms, such as “top,” “bottom,” “front,” “back,” “rear,” “left,” “right,” “up,” “down,” “upper,” “lower,” “inner,” “outer,” “internal,” “external,” “interior,” “exterior,” “proximal,” “distal,” and the like can be used solely to indicate relative directions and/or orientations and may not otherwise be intended to limit the scope of the disclosure, including the specification, invention, and/or claims.

To facilitate understanding, like reference numerals have been used, where possible, to designate like elements common to the figures. Furthermore, alternative configurations of a particular element may each include separate letters appended to the element number. Accordingly, an appended letter can be used to designate an alternative design, structure, function, implementation, and/or embodiment of an element or feature without an appended letter. Similarly, multiple instances of an element and or sub-elements of a parent element may each include separate letters appended to the element number each case, the element label may be used without an appended letter to generally refer to instances of the element or any one of the alternative elements. Element labels including an appended letter can be used to refer to a specific instance of the element or to distinguish or draw attention to multiple uses of the element. However, element labels including an appended letter are not meant to be limited to the specific and/or particular implementation(s) in which they are illustrated. Instead, reference to a specific feature in relation to one implementation should not be construed as being limited to applications only within said implementation. Indeed, systems, methods, apparatus, devices, products, processes, and/or kits, etc., according to certain implementations of the present disclosure may include, incorporate, or otherwise comprise properties, features, components, members, and/or elements described in other implementations disclosed and/or described herein.

The headings used herein are for organizational purposes only and are not meant to be used to limit the scope of the description or the claims.

Implementations of the present disclosure involve systems, methods, and apparatus for improved light fixtures, as well as components and/or sub-components thereof. In particular, implementations of the present disclosure relate to lighting fixtures having a polymer-based frame or structural element. For example, one or more implementations of the present disclosure include systems, methods, and apparatus for a lighting fixture having a light-weight, polymer-based frame element attached to a metal support or structural component. In certain implementations, the lighting fixture is substantially free of underlying metal frame elements capable of casting or otherwise producing a shadow on or through a body portion or display surface of the polymer-based frame element. In at least one implementation, the polymer-based frame element extends from the metal support or structural component such that the body portion of the polymer-based frame element is substantially free of an underlying metal frame or support structure.

Specifically, underlying (metal) frames, frame elements, support structures, and/or hardware can be substantially removed from the body of the supporting structure of polymer-based lighting fixtures, reducing and/or eliminating shadows or other unsightly effects thereof from at least one vantage point. Furthermore, polymer-based lighting fixtures according to certain implementations of the present disclosure can be largely self-supporting about at least a body portion thereof. For example, one or more implementations of the present disclosure include a polymer-based frame element having a body portion extending between a first end and an opposing second end of the frame element. The first end and/or second can be attached to one or more metal or other structural support members and/or the body portion can be self-supporting, such that the body portion is substantially free of any underlying structural support member.

Some implementations, therefore, include lighting fixtures providing light-weight construction and displaying reduced visibility of underlying support elements. The lighting fixtures can include a non-opaque, polymer-based frame element that provides structure without producing a substantial shadow on the outer display surface thereof when illuminated from the inside. The frame element can be attached to and extend (e.g., via suspension) from a rigid support element. A lighting element can be disposed between the support element and a portion of the display surface to reduce a shadow of the support element from being cast on the display surface. The frame element can be wrapped around the support element to conceal the support element from one or more vantage points. The lighting fixture can also be decorated with one or more design elements, which can be connected to the display surface of the frame element.

Some implementations include a non-opaque polymeric frame element having an outer display surface and an opposing inner surface at least partially bounding an inner lighting compartment, a suspension element connected to an upper portion of the frame element, and a lighting element disposed at least partially within the inner compartment of the frame element below the suspension element so that the lighting element does not cast a shadow of the suspension element on a portion of the frame element below the lighting element when the lighting element is illuminated. In addition, the frame element can provide a structural component of the lighting fixture instead of the suspension element. Accordingly, the frame element can be substantially free of an underlying structural component capable of producing a visible shadow on the outer surface.

Some implementations include at least one frame element fastener attaching the upper portion of the frame element to the suspension element, one or more design elements attached to the outer display surface of the frame element, and/or at least one design element fastener attaching the one or more design elements to the outer display surface of the frame element.

Other implementations include a polymer-based frame element configured to provide a structural component of the lighting fixture, the frame element having a first end, an opposing second end, and a body portion extending between said first and second ends. The frame support element can be connected to the first end of the frame element and the lighting element can be disposed at least partially between the frame support element and the second end of the frame element such that the frame support element does not produce a shadow on the body portion of the frame element when the lighting element is illuminated.

In at least one implementation, the frame element has an at least partially tubular or hollow configuration. For instance, at least a portion of the frame element can have a three dimensional shape such as a (whole or partial) cube, cuboid, cylinder, sphere, ellipsoid, cone, pyramid, prism, or torus. The frame element can at least partially bound an inner lighting compartment and/or the body portion of the frame element can at least partially encircle the lighting element such that the lighting element is at least partially disposed within the inner lighting compartment. Accordingly, at least a portion of the frame element can substantially conceal the frame support element from a first vantage point (e.g., from below and/or from the side of a suspended lighting fixture).

In addition, the frame support element can comprise or be formed of a metal or metal alloy (e.g., such that frame support element is opaque). The frame support element can also comprises an outer perimeter and the first end of the frame element can extend about or around the outer perimeter. In one or more implementations, the frame support element does not extend to or into the body portion of the frame element (or a portion of the inner lighting compartment corresponding to the same) such that the body portion is devoid of the frame support element. In particular, the body portion of the frame element can begin at the terminal end of the frame support element connected to the first end of the frame element. Furthermore, the frame support element can have one or more suspension elements configured to retain the frame support element in a suspended configuration (such that the lighting fixture is suspended from a support structure).

The frame element can also comprise a plurality of body elements, each having a first end connected to the frame support element, the first end of the frame element comprising the respective first ends of the plurality of body elements. The plurality of body elements can also have respective second ends opposite the respective first ends thereof. In some implementations, the respective second ends of the plurality of body elements are connected to a bottom portion of the lighting fixture, the bottom portion forming or being disposed at the second end of the frame element. In other implementations, the respective second ends of the plurality of body elements are connected to the frame support element opposite the respective first ends of the plurality of body elements such that the first end of the frame element also includes the respective second ends of the plurality of body elements. Each of the plurality of body elements can further comprise a body portion disposed between the first and second ends thereof. The body portion of the frame element can comprise or be formed of a first portion of the respective body portions of the plurality of body elements and/or the second end of the frame element can comprise or be formed of a second portion of the respective body portions of the plurality of body elements. Alternatively, the frame support element can comprise a base, with the frame element extending upwardly therefrom.

In addition, one or more implementations of the present disclosure can include a method of manufacturing a lighting fixture with a polymer-based frame element. The lighting fixture can be produced by thermoforming a polymeric substrate (sheet) into a three-dimensional structural frame and connecting the frame at one end to the support element. Accordingly, the method can include attaching a polymer-based frame element to a metal or other support structure such that the polymer-based frame element extends from the support structure. In at least one implementation, the support structure is attached to an end of the polymer-based frame element such that a body of the polymer-based frame element is substantially free of an underlying metal or other frame, bracket, or structural support member. In particular, one or more lighting elements associated with the lighting fixture can be positioned (e.g., between the structural support member and the body of the polymer-based frame element) such that any (potential) shadow of the structural support member cast onto the frame element or portion thereof is reduced, minimized, and/or (substantially) eliminated.

Furthermore, one or more implementations of the present disclosure include a polymer-based lighting system having a polymer-based frame instead of a metal frame. In at least one implementation, the system includes a metal or other suspension or base element, a polymer-based frame attached to and extending from the base element, and one or more design features attached to the polymer-based frame. The system can also include one or more lighting elements, including bulbs, LEDs, sockets, wires, wiring, accessories, etc. In at least one implementation, the lighting element(s) can be connected to the metal or other structural support member. In particular, the lighting element(s) can be disposed between the structural support member and a body portion of the polymer-based frame, such that any shadow cast on the body portion by the structural support member is reduced, minimized, and/or (substantially) eliminated. The system can also include one or more fasteners, tools, hardware elements, and/or instructions for assembling the lighting fixture (e.g., according to a method described herein).

In certain implementations, the lighting fixture can include or otherwise be formed from one or more (thermo-flexible) polymer panels, sheets, or other polymer-based material(s). Such panels can be injection molded, extruded, or otherwise formed into any suitable shape and/or size amendable to use in lighting fixtures. Such panels can also be thermoformed (i.e., thermal formed using heat to render the panel pliable, moldable, malleable, or otherwise able to be shaped) or cold-formed (i.e., without additional heating) into a desired shape during assembly and/or formation of the lighting fixture. Moreover, such flexible panels can be folded, manipulated, and/or combined together to form various three-dimensional shapes as can be desired by an assembler or installer. For example, one or more flexible panels can be folded or coupled together to form a substantially cylindrical, conical, cubical, or other shaped lighting fixture.

It will be appreciated that while reference is made to “lighting elements,” “lighting fixtures,” “lighting assemblies,” “lighting modules,” and the like, the present disclosure is not so limited. For instance, some implementations can include a decorative, ornamental, or other design feature unattached to a lighting and/or illumination element. In at o least one implementation, a lighting fixture can comprise an ornamental design fixture and/or assembly that does not include, contain, or comprise an attached lighting element. Some implementations may involve one or more external and/or removed lighting elements or sources. For instance, at least one implementation may rely upon ceiling-mounted or recessed lighting fixtures or elements to provide illumination. Other implementations may involve ambient light, sun light, moon light, and/or reflection(s) thereof. Still other implementations operate by principles entirely or substantially independent of lighting elements, fixtures, or sources.

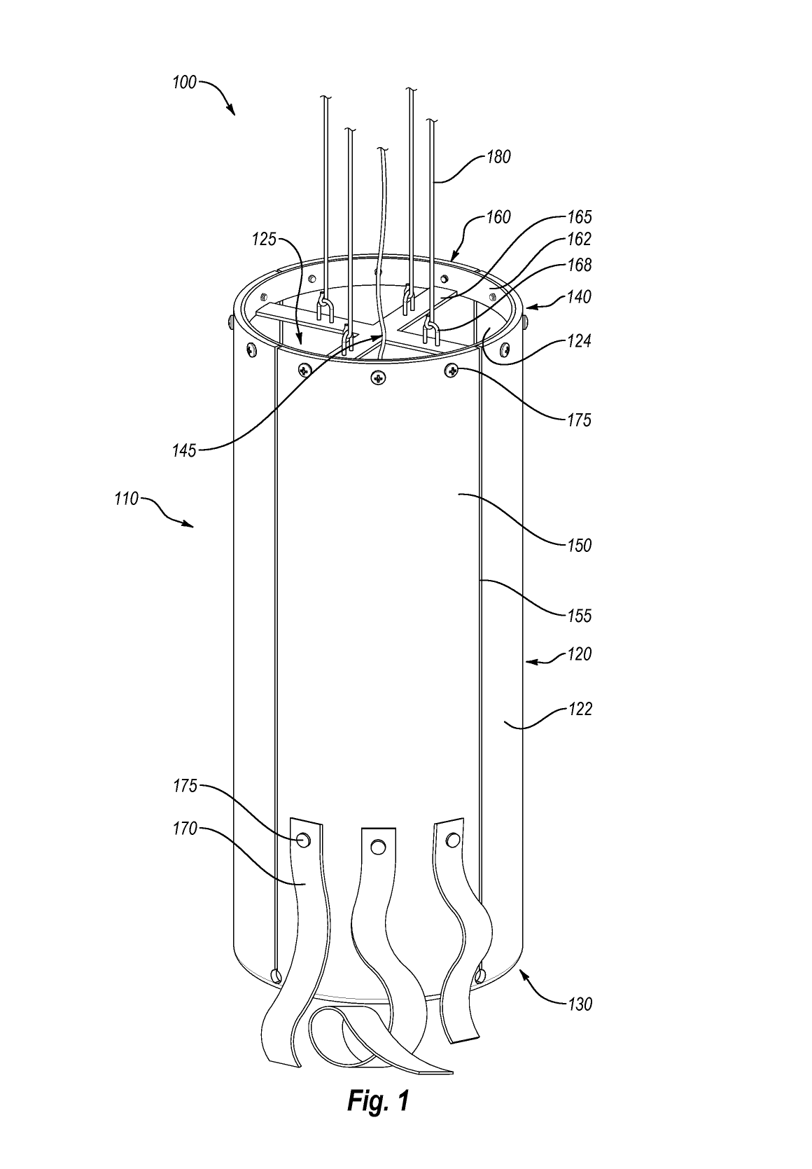

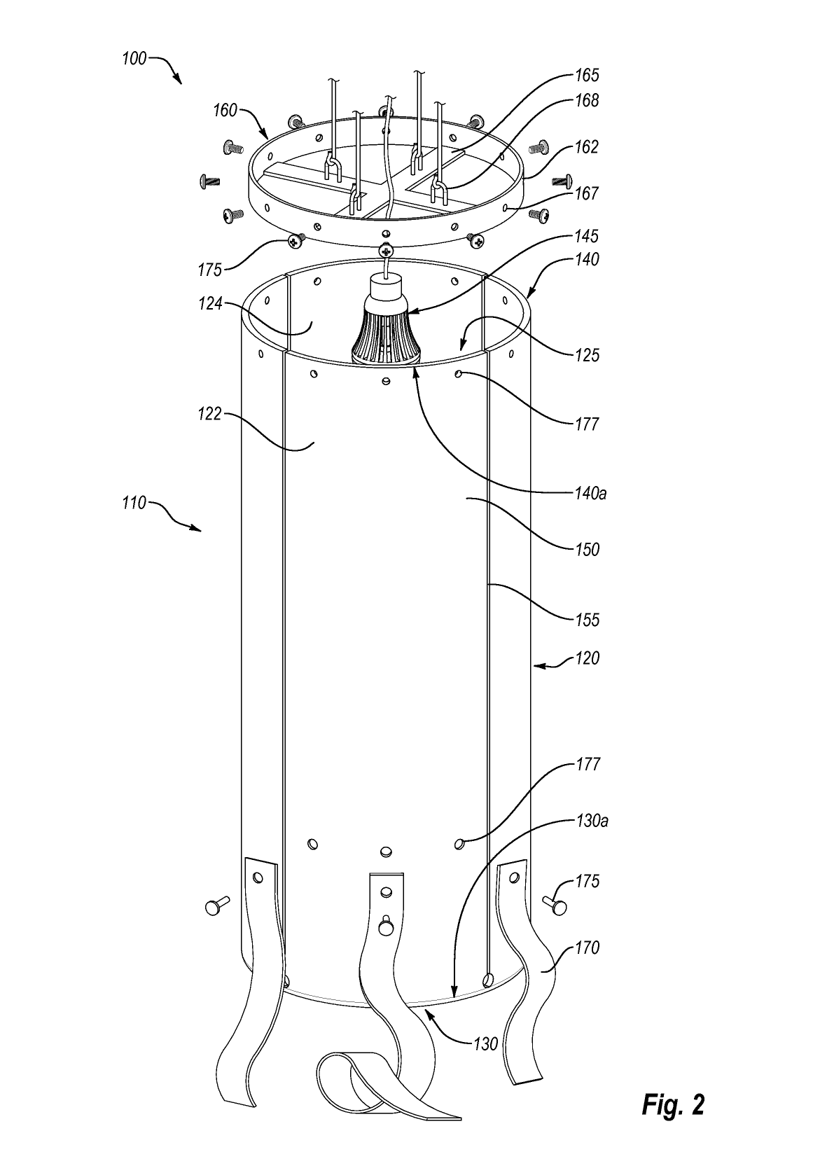

Referring now to the accompanying Figures, FIGS. 1-2 illustrates a top perspective view of a lighting fixture 100 in accordance with an implementation of the present disclosure. As illustrated in FIGS. 1-2, lighting fixture 100 can include at least one frame or frame element 110, at least one support element 160 attachable to frame element 110 (e.g., with one or more fasteners 175), and/or one or more optional design elements 170 attachable to frame element 110 (e.g., with one or more fasteners 175).

FIGS. 1-4 illustrate frame or frame element 110 of lighting fixture 100. Frame element 110 can comprise a body or structural portion 120, an upper, top portion or first end 140, and/or a lower, bottom portion or second end 130. Body portion 120 can extend from or between first end 140 to second end 130. In some implementations, first end 140 and/or second end 130 can comprise a substantially terminal end of frame element 110. Frame element 110 and/or body portion 120 thereof can also have an outer display surface 122 and an opposing inner surface 124 at least partially bounding an inner lighting compartment 125. As illustrated in FIGS. 1 and 2, frame element 110 can have a substantially uniform, cylindrical configuration (between first end 140 and second end 130). In alternative implementations, however, frame element 110 and/or lighting fixture 100 can have another configuration (e.g., non-cylindrical and/or non-uniform).

In certain implementations, body portion 120 can cover or comprise a substantial portion of lighting fixture 100 and/or frame element 110 thereof, or may comprise a base structure thereof. For instance, body portion 120 can comprise, provide, and/or account for greater than 50% of the height, width, length, (surface) area, or other dimension of lighting fixture 100 and/or frame element 110 thereof. In certain implementations, body portion 120 can comprise, provide, and/or account for up to, at least, greater than, between, or about 55%, 50%, 65%, 70%, 75%, 80%, 85%, 90%, 95%, 96%, 97%, 98%, or 99% of the height, width, length, (surface) area, or other dimension of lighting fixture 100 and/or frame element 110 thereof. Similarly, first end 140 and/or second end 130 can comprise, provide, and/or account for less than, between, or about 45%, 40%, 35%, 30%, 25%, 20%, 15%, 10%, 5%, 4%, 3%, 2%, 1%, or 0.5% of the height, width, length, (surface) area, or other dimension of lighting fixture 100 and/or frame element 110 thereof. Accordingly, the majority of lighting fixture 100 and/or frame element 110 thereof can comprise or be comprised of body portion 120.

Furthermore, body portion 120, frame element 110, and/or lighting fixture 100 can comprise any suitable shape and/or size to accomplish the functional and aesthetic design purposes of lighting fixture 100. For example, in at least one implementation, body portion 120 can have or be formed into a substantially (uniform) cylindrical shape, as illustrated in FIG. 1, with a rounded outer surface, comprising a circumference (e.g., such that lighting fixture 100 comprises a substantially cylinder-shaped structure). One will appreciate, however, that the present disclosure is not so limited. For instance, body portion 120 (as well as lighting fixture 100 or a component thereof) can comprise any suitable shape, including a cubical or rectangular block, a tubular conduit, a triangular or pyramidal, or any geometric or abstract shape compatible with lighting fixtures or assemblies. Accordingly, at least a portion of frame element 110 can have a three dimensional shape selected from the group consisting of a whole or partial cube, cuboid, cylinder, sphere, ellipsoid, cone, pyramid, prism, and torus

In certain implementations, frame 110 and/or body portion 120 can include, comprise, or be formed of at least one non-opaque (e.g., transparent or translucent) material configured to allow at least some light to pass therethrough. For instance, frame 110 and/or body portion 120 can disperse, soften, reduce, or alter the appearance of the light in some implementations. Frame 110 and/or body portion 120 can also comprise an aesthetic covering or display for at least one surface of the lighting fixture 100. One will appreciate, however, that frame 110 and/or body portion 120 thereof can comprise an opaque material configured to substantially block, prevent, obstruct, shade, reduce, or impede light from passing therethrough in some implementations without necessarily departing from the scope of this disclosure.

In at least one implementation, the frame 110, body portion 120, and/or other components, elements, and/or features disclosed herein can comprise a polymer, polymer- based, or other flexible panel material. For instance, body portion 120 can comprise a resin, co-polyester, or thermoplastic sheet material. As used herein, the terms “polymer panel,” “polymer material,” “resin panel,” “resin material,” and the like refers to a panel, film, sheet, or other element comprising a substrate of one or more layers formed from any one of the following thermoplastic polymers (or alloys thereof). Specifically, such materials can include, but are not limited to, polyethylene terephthalate (PET), polyethylene terephthalate with glycol-modification (PETG), acrylonitrile butadiene-styrene (ABS), polyvinyl chloride (PVC), polyvinyl butyral (PVB), ethylene vinyl acetate (EVA), polycarbonate (PC), styrene, polymethyl methacrylate (PMMA), polyolefins (low and high density polyethylene, polypropylene), thermoplastic polyurethane (TPU), cellulose-based polymers (cellulose acetate, cellulose butyrate or cellulose propionate), or the like.

In other implementations, body portion 120 (or other components, elements, and/or features disclosed herein) can comprise fabric, paper, or other material whether synthetic, naturally-occurring, or a combination thereof. For instance, body portion 120 can comprise a composite material including recycled and/or post-consumer product(s).

In at least one implementation, the resin, polymeric, or other material of frame 110 and/or body portion 120 thereof can be configured as a rigid or semi-rigid structural component of the lighting fixture 100 such that frame 110 and/or body portion 120 thereof comprises and/or provides a structural element. Accordingly, frame element 110 can provide the structural component necessary to support lighting fixture 100 such that no underlying structural component (capable of producing a shadow) is required. Accordingly, underlying (metal) frame components can be removed and/or eliminated from the body portion 120 of frame element 110 and/or lighting fixture 100 so that body portion 120 of frame element 110 is substantially free of underlying structural components capable of producing a shadow on the inner surface 124, outer surface 122, and/or bottom portion 130 of frame element 110 when lighting element 145 is illuminated. Specifically, in some implementations, lighting element 145 may not directly cast a significant shadow of any structural component on the inner surface 124, outer surface 122, and/or bottom portion 130 of frame element 110 when lighting element 145 is illuminated.

Furthermore, body portion 120 can comprise any suitable thickness or gauge compatible with covering, supporting, and/or otherwise enhancing a lighting fixture 100. For example, the gauge or thickness of the frame 110 and/or body portion 120 in at least one implementation can be anywhere from about one two hundred and fifty-sixth inch (1/256″), or thinner to about one inch (1″), or thicker. In at least one implementation, the gauge or thickness of the body portion 120 can be up to, at least, or approximately one-eighth inch (1/8″), one-sixteenth inch (1/16″), or one-thirty second inch (1/32″). One will appreciate, however, that paper-thin gauge frame elements and/or body portions, block-thick frame elements and/or body portions, and/or any suitable gauge or thickness frame elements and/or body portions can be suitable and/or appropriate in certain implementations.

Likewise, the length, height, circumference, and/or other dimensions of body portion 120, as well as the radius (of curvature) or diameter for frame element 110 (of lighting fixture 100, for example) can comprise any suitable size, shape, or measurement. For instance, in at least one implementation, body portion 120 can have a height of approximately one foot (1′) or less, while other implementations can include a body portion 120 with a height greater than about one foot (1′). For instance, body portion 120 can have a height of about, at least, or greater than two feet (2′), three feet (3′), four feet (4′), six feet (6′), eight feet (8′), twelve feet (12′), or more. One will appreciate that frame 110 and other components, features, and/or members disclosed herein can correspond in or to the length, height, circumference, and/or other dimensions of body portion 120, or may be different, including greater or smaller.

In addition, body portion 120 can comprise any suitable length (e.g., diameter or circumference in a cylindrical-shaped, lighting fixture or other structure 100). For instance, lighting fixture 100 can comprise a cylindrical-shaped structure having a diameter of approximately eight inches (8″) or less. Illustratively, a lighting fixture 100 comprising a cylindrical-shaped structure having a diameter of approximately eight inches (8″) can include a body portion 120 having a length or circumference of approximately four feet (4′) or more. Likewise, in at least one illustrative implementation, a lighting fixture 100 comprising a cylindrical-shaped structure having a diameter of approximately eight inches (8″) can include (or be limited to) a body portion 120 having a height of up to about eight feet (8′). One will appreciate, however, that the present disclosure is not so limited. For instance, lighting fixtures of all shapes and sizes, including diameters of about one foot (1′), three feet (3′), six feet (6′), eight feet (8′), ten feet (10′), fourteen feet (14′), sixteen feet (16′), eighteen feet (18′) or more are contemplated herein. A wide variety of corresponding lengths or circumferences of body portion 120 are also contemplated herein.

In addition, body portion 120 can be accessorized, ornamented, adorned, decorated, or otherwise modified with one or more decorative or design elements 170. In some implementations, design elements 170 can include natural or naturally occurring, synthetic or manufactured, or a combination of materials. For instance, as illustrated in FIG. 1, design elements 170 can comprise polymer or polymer-based-material(s), and/or can be attached by means of one or more fasteners 175. In at least one implementation, design elements 170 can resemble flowers, trees, leaves, celestial bodies, animals, bodies of water, shapes, or any other suitable item or object. In other embodiments, design elements 170 can have or comprise a geometric, curved, rounded, angles, abstract, or other shape. Indeed, design elements 170 can provide the freedom to artistically design and create any imaginable outer display by attaching and/or securing the design elements 170 to the outer (display) surface of frame element 110 and/or body portion 120 thereof.

In at least one implementation, design elements 170 can substantially conceal at least a portion of frame element 110 from one or more vantage points. Accordingly, design elements 170 can cover and/or adorn a significant portion of frame element 110, bottom portion 130, upper portion 140, and/or body portion 120. Design elements 170 can also help to conceal frame support element 160 in some implementations.

Furthermore, certain types of ink, stain, and/or other additions or layers can be provided for decorative and/or ornamental purposes without departing from the scope of this disclosure. For instance, body portion 120 and/or design elements 170 can selectively comprise and/or incorporate a variety of different color and/or texture options as known to those skilled in the art. In other implementations, body portion 120 can also (or alternatively) be shaped to provide an aesthetically pleasing design (e.g., with or without the addition of design elements 170).

As indicated above, lighting fixture 100 can also have a bottom panel or bottom portion 130 (e.g., extending from and/or coupled to the body portion 120). In certain implementations, the size, shape, length, curvature, configuration, and/or other measurement(s) or feature(s) of bottom portion 130 can correspond to the measurement(s) and/or feature(s) of body portion 120. For instance, body portion 120 may have a length, diameter, circumference, or other measurement substantially similar to the length, diameter, circumference or other measurement of bottom portion 130.

Bottom portion or panel 130 can comprise a single or a plurality of bottom portions or panel segments or elements. Bottom portion 130 (and/or other portion(s) of frame 110) can comprise one or more polymeric and/or thermoplastic sheets or panels, such as acrylic (e.g., PMMA), PETG, PC, or another polymer, or can comprise another suitable, versatile material. In one or more implementations, bottom portion 130 of the lighting fixture 100 can be configured to permit light to pass at least partially therethrough. Accordingly, bottom portion 130 can comprise transparent and/or translucent material. One will appreciate, however, that a bottom portion 130 can include opaque material without departing from the scope of this disclosure. In addition, whether transparent, translucent, or opaque, bottom portion 130 can have one or more holes or perforations disposed therein and/or extending therethrough (e.g., to allow for the passage of light therethrough).

In addition, bottom portion 130 may diffuse, disperse, soften, reduce, or otherwise alter the light emitted by or from the lighting fixture 100 and/or lighting element 145 (e.g., as the light passes through the bottom portion 130). For instance, the bottom portion 130 can optionally include a background layer or other treatment feature. Particularly, the bottom portion 130 can have a background layer or coating that can diffuse the light as the light passes through the bottom portion 130. The background layer can comprise a translucent film, a translucent paint, or other coating which can be applied to the front and/or back surfaces of the bottom panel 130. Additionally or alternatively, the bottom portion 130 can have a surface roughness or other features that can deflect and/or diffuse light produced and/or emitted by the lighting fixture or an element thereof. In some implementations, bottom portion 130 can include a separate light diffusing element (e.g., insert) associated there with and/or coupled thereto. Thus, the bottom portion 130 may act as one or more diffusors to help evenly distribute light. Other portions of lighting fixture 100 and/or frame 110 can similarly diffuse, disperse, soften, reduce, or otherwise alter the light (e.g., by a mechanism similar or different mechanism).

In some implementations, bottom portion or panel 130 can also or alternatively provide a structural component of or for the lighting fixture 100 or components thereof. For instance, bottom portion or panel 130 can be configured to structurally support, retain, or hold body portion 120 in a desired shape and/or orientation or provide a structure or other substrate of frame 110.

In one or more implementations, bottom portion 130 can be seamlessly connected to body portion 120. Thus, bottom portion 130 and body portion 120 can comprise a unitary or other single-construction component (albeit a component comprising a plurality of distinct, functional and/or structural elements). In other words, bottom portion 130 can be formed of and/or extend structurally from body portion 120 (or vice versa). In particular, bottom portion 130 is not separately attached to body portion 120 in at least one implementation. In other implementations, however, bottom portion 130 may be separately attached to body portion 120.

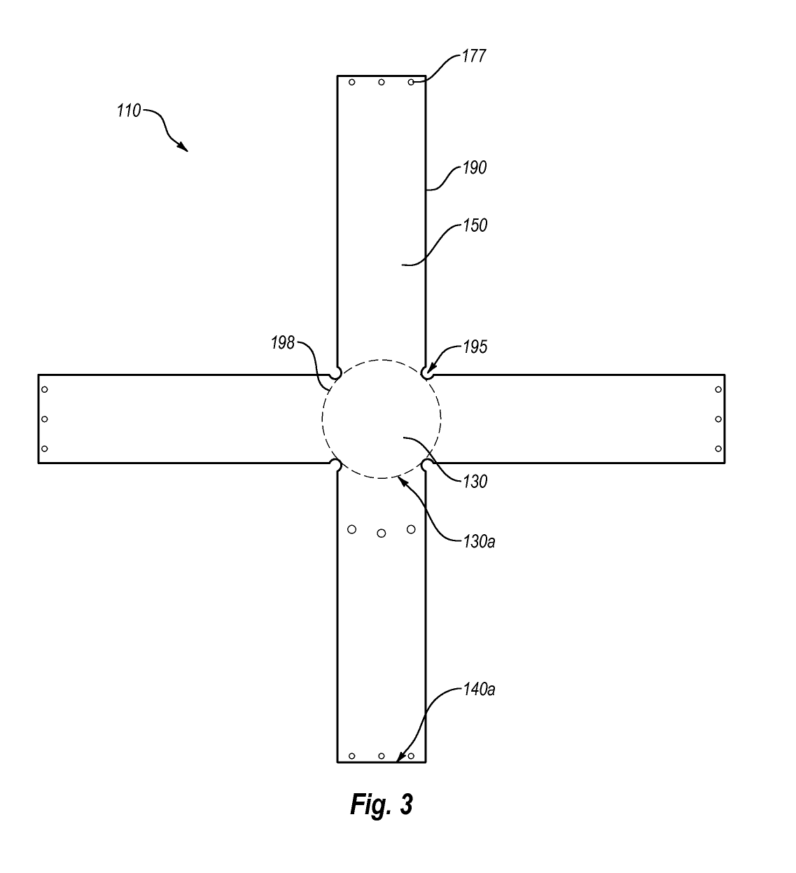

In at least one implementation, body portion 120 can comprise or be comprised of one or more body elements 150. Accordingly, as illustrated in FIGS. 3, bottom portion 130 can have a plurality of body elements 150 (seamlessly) extending therefrom. Body element(s) 150 can comprise segments, modules, or other units of frame element 110 and/or body portion 120 thereof. In at least one implementation, a plurality of body elements 150 can cooperating, combine or be combined, formed, fused, joined, attached, or otherwise associated together to form frame element 110, upper portion 140, lower portion 130, and/or body portion 120. In particular, as illustrated in FIGS. 1-4, a plurality of body elements 150 can be folded together, joined, coupled, connected, overlapped, or otherwise combined to form a body portion 120 of any suitable, required, desirable, and/or conceivable size.

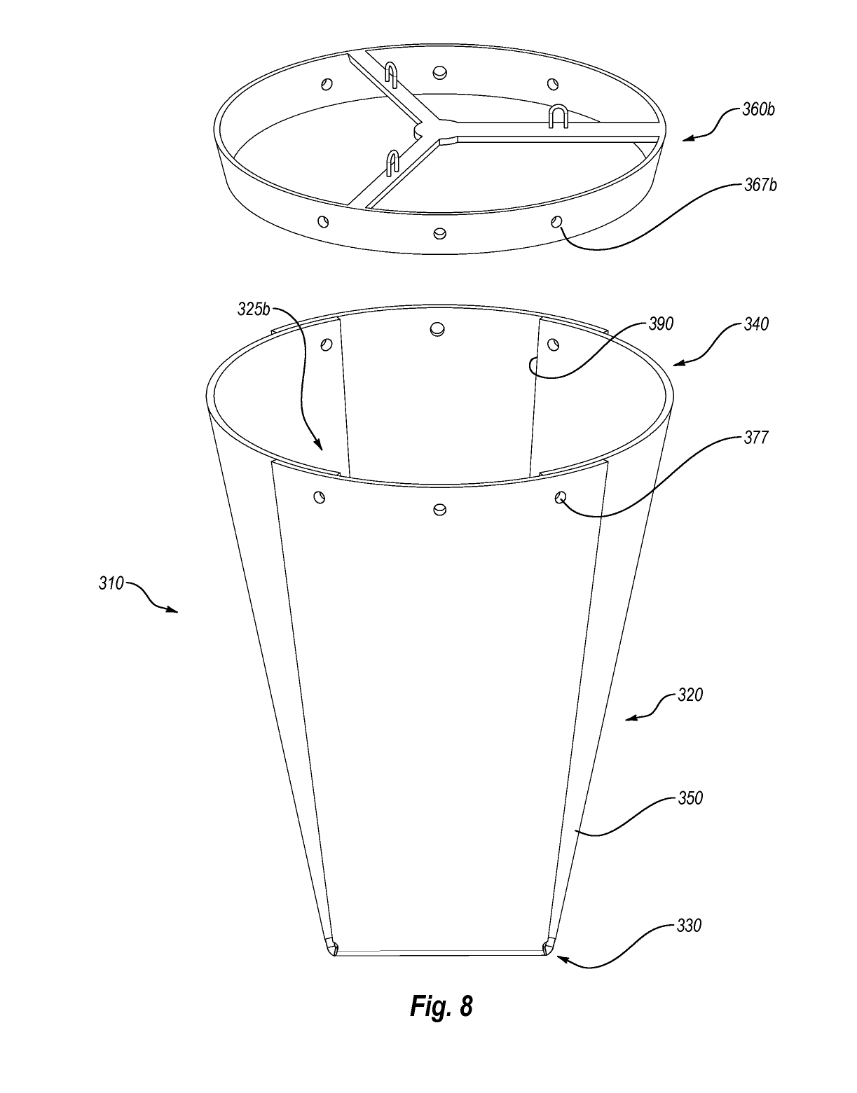

Each body elements 150 can also comprise a lower end 130a (e.g., extending from bottom portion 130) and/or an upper, top end 140a (e.g., configured to be attached to a support element 160 when frame 110 is manipulated into a folded configuration as in FIGS. 1 and 2). Each body elements 150 can also include side edges 190, which can abut (or nearly abut) one or more side edges 190 of an adjacent body element 150 (e.g., when frame 110 is manipulated into a folded configuration as in FIGS. 1 and 2). Alternatively, one or more side edges 190 can overlap or cover one or more adjacent body elements 150 and/or side edges 190 thereof (see e.g., FIG. 8).

Frame element 110 can also include an indent, carve-out, gap, crater, or other design or structural feature 195. In at least one implementation, indent 195 can be provided and/or configured to permit the structural assembly of frame element 110 into a folded configuration. Similarly, frame element 110 can also include one or more perforation, crease, or other design or structural feature 198 configured to enhance or improve the structural assembly of frame element 110 into a folded configuration. In at least one implementation, lighting fixture 100 and/or frame element 110 can include a form retention member (e.g., about which at least a portion of frame element 110 can be formed and/or folded. For instance, lighting fixture 100 and/or frame element 110 can include a disc-shaped form retention member (not shown) inside inner lighting compartment 125 (e.g., at or near bottom portion 130) to retain the circular shaped bottom portion 130 and/or body portion 120. Such a form retention member can be comprised of a non-opaque material such that light from lighting element 145 can pass at least partially therethrough. Importantly, the optional form retention member may not produce a shadow on the inner surface 124, outer surface 122, and/or bottom portion 130 of frame element 110 when lighting element 145 is illuminated. Specifically, lighting element 145 may not cast a shadow of the form retention member on the inner surface 124, outer surface 122, and/or bottom portion 130 of frame element 110 when lighting element 145 is illuminated.

Furthermore, body elements 150 can form one or more seams 155 therebetween. For instance, respective side edges of adjacent body elements 150 can meet to form seam 155. It will appreciate, however, that seam 155 can also be formed by overlapping body elements 150 in certain implementations (see e.g., FIG. 8). Body element(s) 150 can (seamlessly) extend from first end 140 and/or second end 130 in some implementations. However, body element(s) 150 can also or alternatively comprise one or more separate and/or distinct pieces coupled together to form frame element 110 and/or body portion 120 thereof. Accordingly, as illustrated in FIGS. 2-4, body element(s) 150 can (each) comprise a first end 140a and/or second end 130a.

As indicated above, body portion 120 (and/or body element(s) 150) can include first and second surfaces (e.g., inner surface 124 and outer surface 122), which can be fabricated, manufactured, formed, and/or treated to accomplish a specific design or aesthetic effect. For instance, outer display surface 122, especially, of body portion 120 (and/or body element(s) 150) can be colored, shaded, textured, or otherwise modified in a variety of different ways and can, thereby, provide a large variety of images, designs, and other aesthetically pleasing enhancements. Body portion 120 (and/or body element(s) 150) can also be shaped to provide an aesthetically pleasing design. In addition, inner surface 124 and/or outer surface 122 can have a light diffusing layer applied thereto and/or disposed thereon.

In at least one implementation, bottom portion or panel 130 and/or body portion 120 can at least partially conceal from view one or more lighting elements or components 145 (e.g., light bulbs, LEDs, wiring, accessories, etc.) housed, disposed, and/or otherwise positioned within the lighting fixture 100 (e.g., from at least one vantage point). For instance, frame element 110 can at least partially bound an inner lighting compartment 125. Lighting element 145 can be at least partially disposed in inner lighting compartment 125 such that body portion 120 substantially conceals lighting element 145 from a lateral and/or side vantage point. Similarly, bottom portion 130 can substantially conceal lighting element 145 from a lower and/or bottom vantage point. Thus, in the case of a ceiling-suspended lighting fixture 100, lighting element 145 may not be visible from below. In some implementations, lighting element 145 may not be housed, disposed, and/or otherwise positioned within the lighting fixture 100. For instance, lighting element 145 may be disposed behind lighting fixture 100 and/or frame element 110 thereof.

As indicated above, lighting fixture 100 can optionally include a metal or other frame support element 160. In certain implementations, support element 160 can provide and/or comprise: an attachment point or interface for frame element 110 and/or one or more elements or portions thereof; a mounting, supporting, and/or suspension mechanism for lighting fixture 100 and/or one or more elements thereof; and/or a frame support element or member for reinforcing or otherwise providing structural support to or for the lighting fixture 100, frame element 110, and/or one or more element(s) or component(s) thereof. For instance, in at least one implementation, the one or more lighting elements 145 can be attached to (e.g., suspended from) support element 160. In particular, lighting element(s) 145 can be disposed between the support element 160 and body portion 110 of the frame 100, such that any (potential) shadow cast on the body portion by support element 160 is reduced, minimized, and/or (substantially) eliminated. Thus, in the case of a ceiling-suspended lighting fixture 100, lighting element 145 may be disposed within inner lighting compartment 125 below frame support element 160.

Support element 160 can comprise, metal, resin, wood, plastic, bone, or any other suitable material or derivative or alloy thereof. In certain implementations, support element 160 comprises aluminum or aluminum alloy. In other implementations, support element 160 comprises polymer or a polymer-based material. In some implementations, support element 160 is structurally adapted to support the weight of lighting fixture 100 and/or component(s) thereof in a suspended configuration. For instance, lighting fixture 100 can hang down from a ceiling or other elevated support structure. So suspended, frame support element 160 may be secured to the elevated support structure above and may structurally withstand the weight of lighting fixture 100 without substantial deformation.

As illustrated in FIG. 1, support element 160 can comprise a ring or other rounded shape or configuration. One will appreciate, however, that the present disclosure is not so limited. For instance, support element 160 can comprise a square, triangle, or any other suitable geometric, rounded, or other shape or a plurality thereof. Thus, support element 160 can comprise any suitable shape including round or circular, cylindrical, square or rectangular, cubical, triangular, trapezoidal, pyramidal, or any other geometric, rounded, curved, or abstract shape.

Support element 160 can also be appropriately sized according to the lighting fixture 100 or frame 110 Likewise, whereas FIG. 1 illustrates perpendicular support bars (or cross-bars) 165, in other implementations, any suitable mechanism for maintaining the structural integrity of support structure 160 can be included. In some implementations, no additional support mechanism is required and/or included.

In one or more implementations, support element 160 can be attached to frame 110 at upper, top portion or second end 140. In at least one implementation, upper, top portion or second end 140 can be attached to support element 160 by means of one or more fasteners 175. Illustrative fasteners 175 can comprise one or more rivets (including metal or nylon rivets and the like), screws (including metal threaded screws and the like), bolts, adhesives, clasps, magnets, clamps, or any other means for attaching or fastening a first object to a second object.

Support element 160 can also include one or more suspension or support members 168. For instance, support element 160 can include a plurality of suspension members 168 by which lighting fixture 100 can be hung, suspended, or otherwise supported. In certain implementations, one or more wires, cable, or other suspension apparatus 180 can attach to and/or suspend lighting fixture 100 (e.g., by means of suspension or support member(s) 168). As illustrated in FIG. 1, support element 160 can comprise and/or provide an upper support structure for lighting fixture 100 and/or frame 110 thereof. In at least one implementation, lighting fixture 100 comprises a chandelier or other hanging or suspended lighting element. Thus, lighting fixture 100 can be hung, suspended, or otherwise supported from, by or by means of support element 160 and/or mounting, supporting, and/or suspension mechanism 168 thereof. One will appreciate, however, that the present disclosure is not so limited. For instance, lighting fixture 100 can comprise a lamp or other supported lighting structure. In particular, lighting fixture 100 can extend from and/or be supported by a floor, sub-floor, wall, partition, divide, pillar, ceiling, sub-ceiling, or any other structural support feature of a room, building, or design space.

In an illustrative implementation, support element 160 is positioned, attached, and/or confined to a specific portion of lighting fixture 100. For instance, support element 160 can be attached and isolated to first end 140 of lighting fixture 100. In some implementations, first end 140 can be or comprise a terminal end of frame element 110. In other implementations, however, a portion of frame element 110 (e.g., first end 140) can extend above or beyond support element 160. As indicated above, in certain implementations, support element 160 and/or lighting element 145 can be positioned such that support element 160 does not cast or produce a substantial shadow onto at least a portion or part of body portion 120 and/or bottom portion 130. In implementations where a portion of frame element 110 (e.g., first end 140) can extend above or beyond support element 160, however, a lighting element 145 may cast a shadow of support element 160 on such above-extending potion(s) without necessarily departing from the scope of this disclosure. In additional implementations, a second lighting element 145 may be disposed above support element 160 to reduce the shadowing effect above the support element 160.

Thus, lighting fixture 100 can comprise a polymer-based frame and a substantially concealed metal or other support element such that the support element does not cast or produce a shadow onto the frame or body portion thereof when lighting fixture 100 is illuminated. Such a configuration can provide an advantage in aesthetic design, as shadows from frame elements detract from the appeal of lighting fixtures and other display elements disclosed, described, and contemplated herein.

In another implementation, support element 160 does not occupy a space, plane, or cross-section occupied by body portion 120. In particular, frame element 110 and/or body portion 120 thereof can have an outer display surface 122. Support element 160 can be connected to frame element 110 above display surface 122 in some implementations. Thus, body portion 120 of frame element 110 is not directly attached to support element 160 in at least one implementation. Furthermore, in some implementations, frame element 110 extends from support element 160 such that a display portion of lighting fixture 100 is devoid of any part or portion of the support element 160. Thus, lighting fixture 100 can comprise a first portion or end having a metal or other support element 160 and/or being (directly) structurally supported thereby, and a second portion or end that is not (directly) structurally supported by metal or other support element 160.

FIG. 2 further illustrates that support element 160 can include outer ring 162, supports or cross-bars 165, and/or one or more eyelets, loops, or other suspension or support members 168. Similarly, frame 110 can include upper portion 140, lower portion 130, and middle or body portion 120 therebetween. Upper portion 140 can include one or more holes or other attachment interfaces 177 (e.g., for coupling, securing, or otherwise attaching support element 160 to frame element 110 and/or upper portion 140 thereof). Support element 160 and/or outer ring 162 thereof can have corresponding holes disposed therein and/or extending therethrough. Body portion 120 can include one or more body elements 150. For instance, body portion 120 can include one, two, three, four, five, six, or more body elements 150.

In at least one implementation, frame element 110 and/or a portion thereof can cover at least a portion of support element 160. For instance, as illustrated in FIG. 1, upper portion 140 of frame element 110 substantially covers the outer surface of outer ring 162. Thus, when viewed from beneath (i.e., from a vantage point extending from lower portion 130 towards upper portion 140), visibility of support element 160 may be reduced, inhibited, and/or eliminated. Accordingly, in certain implementations, support element 160 is not directly visible from one or more vantage points.

Those skilled in the art will appreciate that the absence of a large, fully-supporting metal frame or frame element (e.g., connected to body portion 120) can significantly decrease the weight of lighting fixture 100. Furthermore, owing to the cost of purchasing, manufacturing, and/or constructing such a fully-supporting metal frame or frame element(s)—including welding costs—lighting fixture 100 can advantageously cost substantially less to produce and/or assemble.

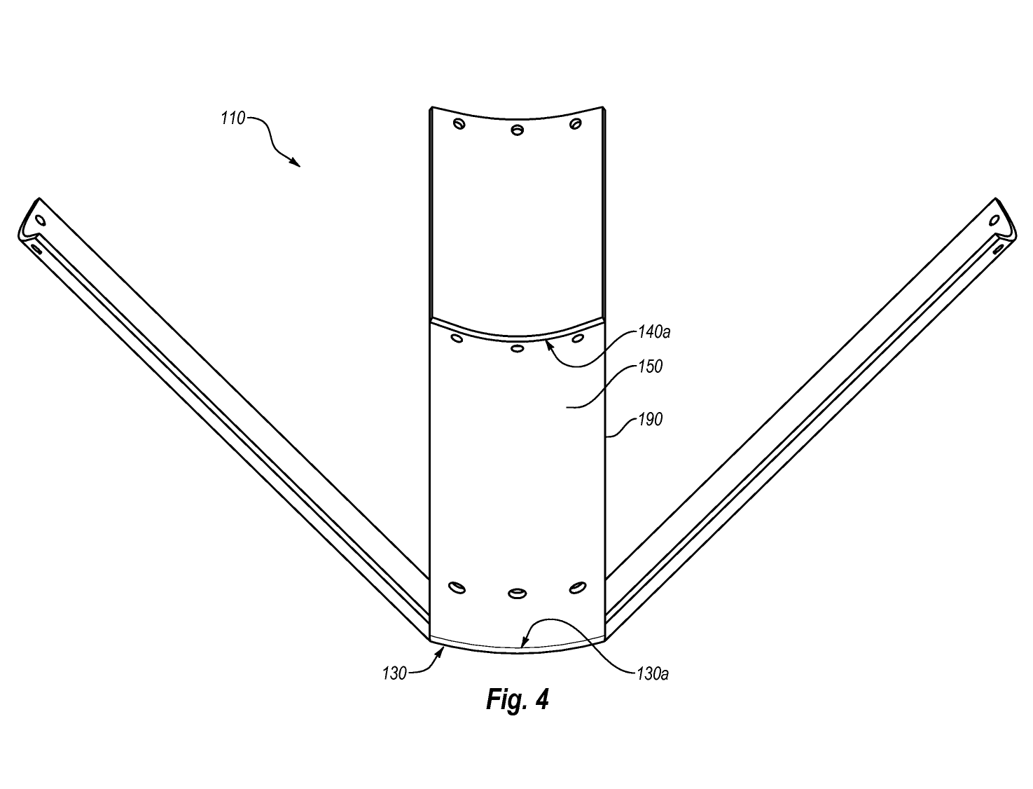

FIGS. 3 and 4 further illustrate a method of forming frame 110 for use in forming lighting fixture 100. In particular, FIG. 3 illustrates frame element 110 in an unfolded configuration, illustrating that, in at least one implementation, frame 110 can be extruded, fabricated, manufactured, and/or formed in a substantially flat configuration. FIG. 4 illustrates frame 110 in a partially folded configuration, illustrating that, in at least one implementation, the shape of frame 110 can be manipulated. For instance, in one or more implementations, frame 110 can be thermoformed into a shape suitable for forming a lighting fixture. Specifically, as illustrated in FIG. 4, body elements 150 can be partially folded, upwardly, away from lower, bottom portion 130. As illustrated in FIGS. 1 and 2, body elements 150 can be folded so as to extend substantially perpendicularly away from bottom portion 130, forming a substantially cylindrical frame element 110 and/or body portion 120. Accordingly, body elements 150 can be thermoformed into a curved or rounded shape to create a curved or rounded body portion 120, frame element 110, and/or lighting fixture 100.

In at least one implementation, a forming member (not shown) may be used to thermoform frame element 110. For instance, a cylindrical-shaped forming member (e.g., mold, model, frame, and/or pattern) may be places on or about heated frame element 110 such that body elements 150 can be folded and/or molded around the forming member (substantially adopting the shape thereof). Accordingly, the shape of crease 198 can correspond substantially to the shape of the optional forming member in some implementations. Those skilled in the art will appreciate, however, that use of a rectangular-shaped forming member (e.g., rectangular prism) can cause crease 198 to adopt a square- and/or rectangular-shaped configuration. Accordingly, the same configuration of frame element 110 can be used to create a plurality of differently shaped frame elements 110 (e.g., cylindrical, rectangular prism, tubular, etc.). Thus, the substantially planar configuration of frame element 110 illustrated in FIG. 3 can provide an advantage during thermoforming of the shaped frame element 110 illustrated in FIGS. 1 and 2 (via the partially-folded intermediate illustrated in FIG. 4).

The planar configuration of unfolded frame 110 illustrated in FIG. 3 also provides an advantage over metal and pre-constructed frames in the area of transport, shipping, handling, or otherwise moving components of lighting fixture 100. For instance, frame 100 can be shipped and/or sold in a flat box or other easily handled or managed container, and can optionally be shipped together with other components of lighting fixture 100. In at least one implementation, an unassembled lighting fixture (or lighting system or kit) 100 can be sold in one or more boxes or containers. Thus, certain implementations can also include one or more design elements, fasteners, lighting components, suspension components, and/or assembly instructions. Other design and structural accessories, including image, color and/or texture elements are contemplated herein.

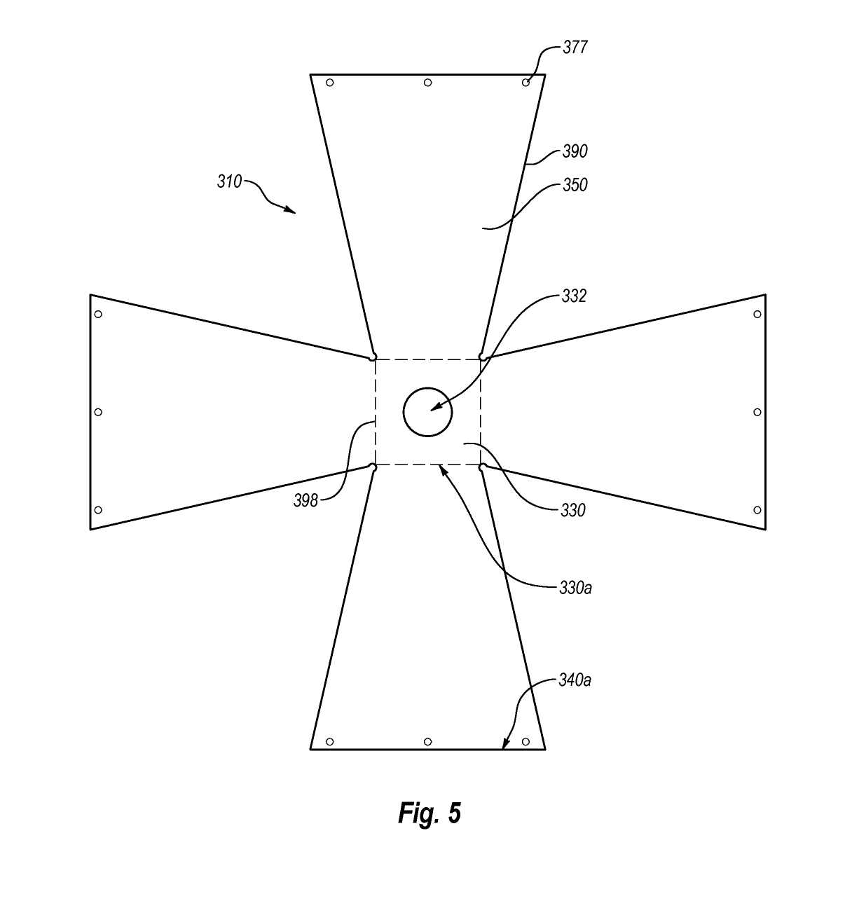

FIGS. 5-8 illustrate alternative implementations relating to the lighting fixture of the present disclosure. FIG. 5 illustrates a top plan view of an unfolded, polymer-based frame element 310 in accordance with another implementation of the present disclosure. Frame element 310 can be configured similar to frame element 110, with one or more of the depicted and/or described alterations. As illustrated in FIG. 5, frame element 310 can include one or more body elements 350 extending from a bottom portion 330. In addition, whether transparent, translucent, or opaque, bottom portion 330 can have one or more openings, holes, or perforations disposed therein and/or extending therethrough (e.g., to allow for the passage of light therethrough). Thus, bottom portion 330 can comprise an open configuration in at least one implementation. As illustrated in FIG. 5, bottom portion 330 can have at least one opening 332 extending therethrough. An optional frame insert (not shown) can be disposed over or about opening(s) 332 to structurally support frame element 310 and/or bottom portion 330 (e.g., to maintain a desired shape thereof) and/or diffuse light passing out of opening(s) 332.

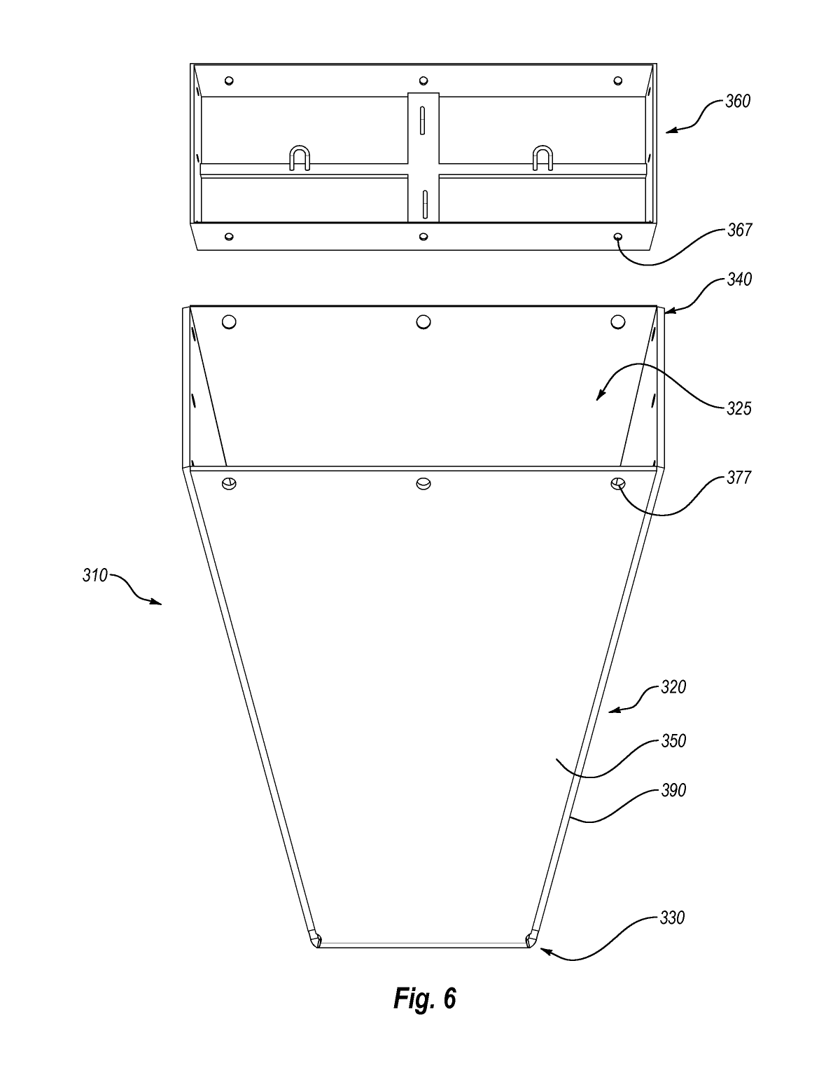

FIG. 5 also illustrates that body elements 350 can comprise a variable shape between opposing side edges 390 (along the lengths thereof). For instance, body elements 350 comprise substantially triangular or trapezoidal shapes (as depicted in FIG. 5) such that upper end 340a is substantially wider than lower end 330a. The trapezoidal shape of body element 350 can provide versatility in forming a lighting fixture having one of a plurality of different configurations, as illustrated in FIGS. 6-8). Thus, in a folded configuration, frame element 310 can adopt a plurality of different shapes.

For instance, as illustrated in FIG. 6, frame element 310 can be manipulated (e.g., thermoformed and/or folded) into a trapezoidal prism having an inner compartment 325. Specifically, by maintaining a substantially square-shaped bottom portion 330 and by joining side edges 390 (e.g., without a significant overlap), frame element 310 can be thermoformed into a trapezoidal prism having a (smaller) substantially square-shaped bottom portion 330 and a (larger) substantially square-shaped upper portion 320. A square-shaped suspension or support element 360 can be attached to upper end 340 by aligning openings 367 with opening 377 and inserting fasteners into aligned openings 367, 377. As indicated above, however, other fasteners and/or fastening mechanisms are also contemplated herein.

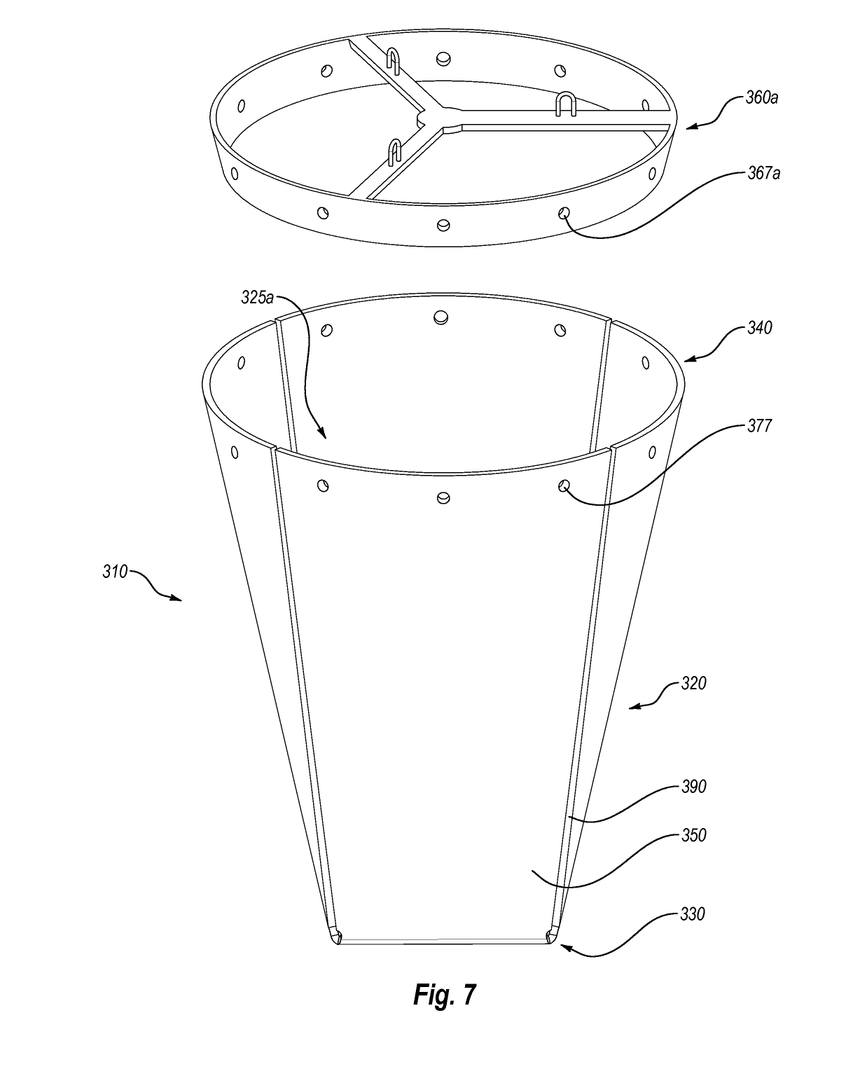

Body elements 350 can also be thermoformed into an at least partially rounded or angled configuration. For instance, as illustrated in FIG. 7, body elements 350 can be manipulated so as to for an at least partially conical-shaped frame element 310 having an inner compartment 325a. In a specific implementation, for example, by maintaining a substantially square-shaped bottom portion 330, by rounding body elements 350, and by joining side edges 390 (e.g., without a significant overlap), frame element 310 can be thermoformed into a square-base cone-shaped frame element 310. A circular-shaped suspension or support element 360a can be attached to upper end 340 by aligning openings 367 with opening 377 and inserting fasteners into aligned openings 367, 377. It will also be appreciated that upper end 340 and/or suspension or support element 360a can have an oval or oblong shape in certain implementations.

FIG. 8 illustrates another variation for thermoforming frame element 310 into an at least partially rounded or angled configuration. Specifically, by maintaining a substantially square-shaped bottom portion 330, by rounding body elements 350, and by overlapping side edges 390, frame element 310 can be thermoformed into an alternative square-base cone-shaped structure having a rounded (e.g., substantially circular or oval) upper portion 340, a square-shaped bottom portion 330, and an inner compartment 325b. While FIGS. 7 and 8 both depict these hybrid square-conical-shaped frame elements 310, because of the overlap in side edges 390, inner compartment 325b is smaller (e.g., less volume) that inner compartment 325a. Accordingly, a circular-shaped suspension or support element 360b—that is smaller than suspension or support element 360a—can be attached to upper end 340 by aligning openings 367 with opening 377 and inserting fasteners into aligned openings 367, 377, as depicted in FIG. 8.

Those skilled in the art will also appreciate that bottom portion 330 can alternatively comprise a rounded (e.g., substantially circular or oval) shape in a folded configuration. Accordingly, in a folded configuration, frame element 310 can comprise a (rounded bottom-rounded top) conical shape in some implementations. Those skilled in the art will also appreciate that bottom portion 330 can alternatively comprise a rectangular, pentagonal, hexagonal, or other geometric or angled shape. Indeed, by altering the thermoforming process (without necessarily altering the frame element 310) frame 310 can be folded and/or thermoformed so as to form or adopt a variety of configurations, including a cylindrical shape or even an inverted conical shape (e.g., when edges 390 substantially overlap). One will appreciate, however, that the present disclosure is not so limited. For instance, frame 310 can comprise any three-dimensional shape and/or size. Likewise, edges 390 can comprise variable rounded, smooth, squared, and/or jagged configuration(s). Accordingly, (the same) frame element 310 can be thermoformed into a variety of configurations. Such versatility can be a desirable, cost-effective, and/or efficient feature in lighting fixture design and construction.

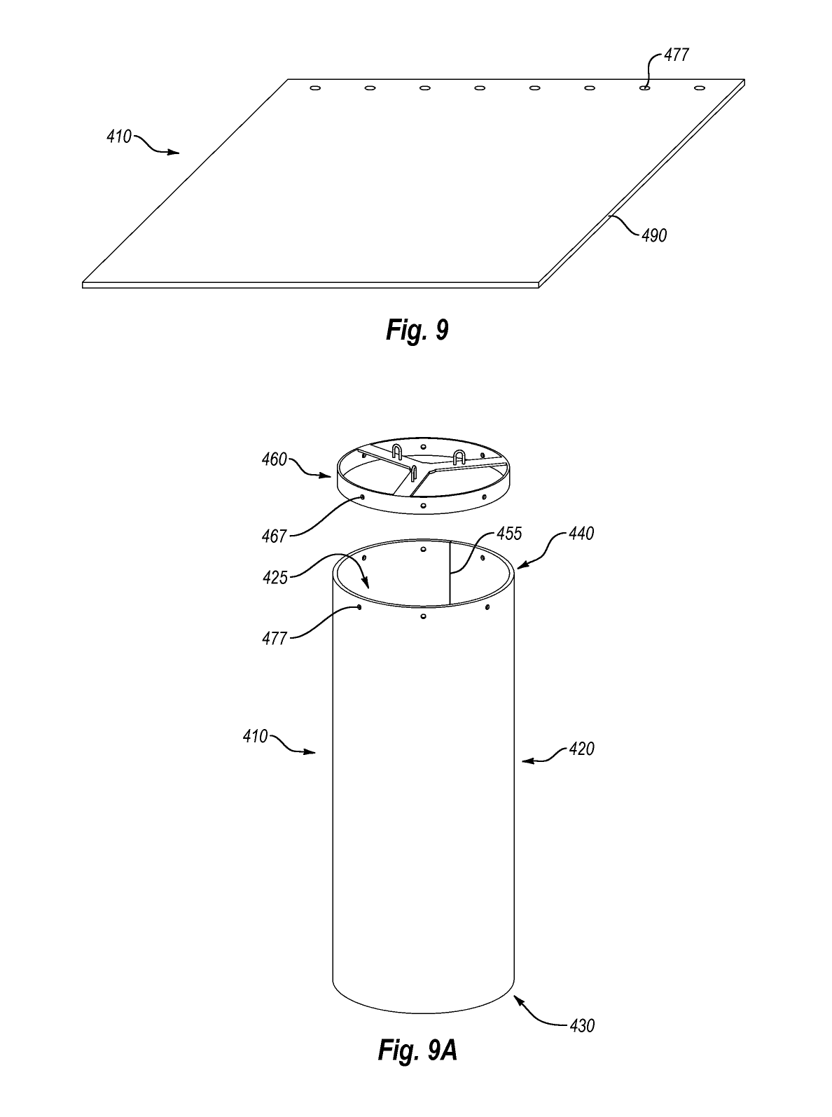

One will also appreciate, that some implementations may not include a bottom portion for aesthetic, design, functional, or other purposes. Indeed, artistic lighting and/or other displays can be highly customizable and can comprise any suitable number of features described herein. Importantly, certain features described herein can be altered or even eliminated with departing from the scope of this disclosure. For instance, certain implementation may not include a plurality of body elements extending from a bottom portion. Other implementations may be devoid of a bottom panel at the lower portion. As illustrated in FIGS. 9-9A, for instance, a frame element 410 can comprise a (rectangular or square) sheet of polymeric material (FIG. 9) thermo-formable into a substantially cylindrical structure (FIG. 9A) having opposing open ends 430, 440. FIG. 9A further illustrates a seam 455 formed at the joining of opposing ends 490 of frame element 410. Those skilled in the art will appreciate that one or more separate bottom portions (not shown) and/or design elements (not shown) may be attached to frame element 410 to substantially cover and/or conceal an open end thereof.

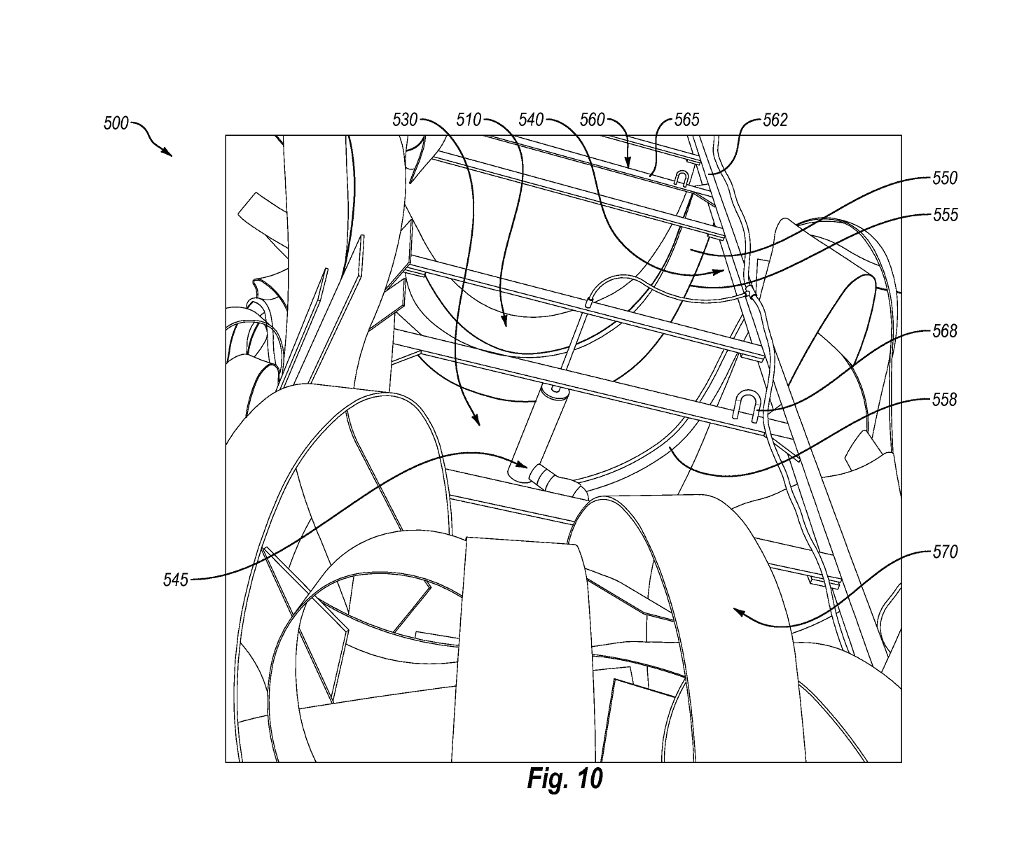

FIG. 10 illustrates another alternative configuration for a lighting fixture 500 according to an implementation of the present disclosure. Similar to other implementations described herein, lighting fixture 500 includes a polymer or polymeric frame or frame element 510 having an upper portion 540 attached to a support element 560 (e.g., by means of one or more fasteners (not shown)). However, as illustrated in FIG. 10, body portions 550 extend from a first side of support element 560 to the opposing side thereof, the middle of body portions 550 forming the bottom portion 530 of frame element 510.

As depicted in FIG. 10, support element 560 has a ladder-like configuration, with transverse support bars 565 extending across (or between) outer ring or longitudinal support beams 562. Accordingly, body portions 550 loop downward from a first longitudinal support beam 562 to the opposing longitudinal support beam 562, forming a canoe- or boat-shaped structure; the body portions 550 serving as (or analogous to) the ribs of a ship or other (water) vessel. In at least one implementation, body portions 550 can overlap or align to form a seam 555.

In continuing analogy, lighting fixture 500 can further comprise longitudinal shiplap, garboard, and/or strake (not shown) disposed and/or running longitudinally along the body portion 550 ribs. Such additional elements can wrap the outside of the polymeric frame and can similarly comprise polymeric and/or non-opaque material.

Lighting fixture 500 can also include one or more form retention members 558 dispose about frame element 510. In at least one implementation, form retention member 558 can comprise a polycarbonate or other polymeric (laser-cut) rib component about which frame element 510, body portions 550, and/or wrapping strake (not shown) can be organized so as to maintain a predetermined shape. An outer design feature can also be attached to the frame element 510 or wrapping thereof. For instance, FIG. 10 illustrates a plurality of design elements 570, which can be disposed about the outer surface of the polymeric frame element 510.

Support element 560 can also have one or more suspension member 568, from which support element 560 can be suspended from a ceiling or other elevated support structure. Lighting fixture 500 can alternatively be mounted to a wall, floor, or other support structure. Lighting fixture 500 can also include one or more lighting elements 545. In at least one implementation, lighting elements 545 can be suspended from and/or be disposed below support element 560 within the hull of the canoe-shaped frame element 510, as depicted in FIG. 10.

In at least one implementation, lighting fixture 500 can comprise a modular lighting fixture including a plurality of lighting modules. Such modules can be connected together to form a lighting fixture having any suitable longitudinal length. Lighting fixture 500, and indeed, each lighting module thereof can comprise one or more upper support elements attached to an upper portion of a polymer-based frame. Suspension members or elements, as well as various lighting elements can also be attached to the support members. Furthermore, the frame can include a body portion having design elements attached thereto. The body portion can be seamlessly connected to a bottom portion of the frame.

An illustrative method of producing a (light-weight, aesthetically pleasing, or other) lighting fixture in accordance with an implementation of the present disclosure can include providing a polymer-based frame or frame component. The frame or frame component can, for example, be provided in a first configuration. The first configuration can comprise a substantially planar or flat configuration. Alternatively, the first configuration can comprise an unsecured and/or unattached configuration. In certain implementations, the method can include manipulating (e.g., thermoforming) the polymer-based frame component into a second configuration. Manipulating the polymer-based frame component into a second configuration can form a structural frame element and/or can position the frame component for attachment and/or securing to one or more additional components. For instance, the frame component can be folded into a three-dimensional frame configured as a suspension or base structure.

In at least one implementation, the frame element of the present disclosure can be self-supporting (i.e., without any metal or other (underlying) support structure or element). For instance, the polymer frame can be structurally sound such that no additional structural components are required to form the base structure. However, attachment and/or securing hardware can still be utilized where appropriate without departing from the scope of this or other implementations of the present disclosure. For example, one or more fasteners can be used to retain, maintain, or secure the frame in a desired position or configuration. In addition, one or more additional structural support elements can be attached to at least a portion of the frame without necessarily departing from the scope of this disclosure. For example, a suspension or support element can be attached or secured to a first end of the frame to permit the lighting fixture to be hung from a structural member or to hold the frame in a desired configuration.

The method can also include securing the polymer-based frame component in the second configuration. Thus, the method can include securing elements of the frame component together and/or to a suspension or support element. One or more fasteners, as described above, can be used to secure the frame component. Illustrative methods can also include suspending the frame support element from a support structure such that the lighting fixture is suspended from the support structure and/or activating a lighting element disposed at least partially within the lighting fixture.

In a preferred implementation, the configured frame is capable of producing a desired aesthetic without a visible shadow of or from the support element appearing or being cast on the frame component or an outer or display surface thereof. Thus, the present disclosure includes a method of producing a lighting fixture having reduced or eliminated visibility of one or more structural or other components. In particular, the frame can comprise a body portion configured to provide a display surface. The display surface can provide and/or receive one or more display or other elements. In at least one implementation, the method also includes attaching and/or securing one or more design elements to the frame component or an outer or display surface thereof.

In some implementations, a lighting fixture can be configured to display reduced visibility of support, connecting, and/or mounting hardware components. For example, underlying support elements can be eliminated from at least a portion of the body of the lighting fixture owing to the structural rigidity and/or support provide by the polymer-based frame and/or frame elements. Specifically, any required metal or other support or suspension hardware can be positioned at an end of the frame such that a shadow of said support or suspension hardware is not produced on the body portion and/or viewing surface of the lighting fixture. Such shadows can detract from the aesthetic appeal of the lighting fixture, including design elements decorating the surface thereof.

In addition, the polymer-based frame configuration of certain implementations can reduce or even eliminate the need to diffuse, mask, hide, or reduce visibility of an underlying, attached, or otherwise associated metal or other frame element, whether structural or aesthetic. Indeed, in at least one implementation, shadows otherwise cast onto the polymer material are reduced and/or eliminated by replacing an underlying or other frame element with polymer-based structural components. Thus, in at least one implementation, an aluminum frame is replaced by a polymer-based frame. The polymer-based frame can be wrapped, covered, adorned, or decorated with one or more outer layers and/or design elements. In some implementations, the one or more outer layers and/or design elements can comprise polymer-based material(s). The polymer-based construction can also reduce the overall weight and/or cost of manufacturing, producing, assembling, and shipping of lighting fixtures in certain implementations.

In at least one implementation, the polymer frame comprises a unitary polymer-based substrate. For example, the substrate can be provided as a planar or otherwise configured element capable of being folded or manipulated into a structurally sound, three-dimensional lighting fixture frame. A top or end portion of the frame can be attached to a suspension support member so as to form a hanging chandelier, to a base structure to form a supported lamp or other fixture. The substrate can also include a plurality of body, side, or other components configured to abut or overlap an adjacent component. Thus, seams between components of the unitary or other substrate can be present in the lighting fixture or frame thereof without departing from the scope of this disclosure.

Moreover, no additional cover, lid, or under-layer is required in at least one implementation. Thus, the lighting fixture can be enclosed, especially from below. Other implementations can include an additional covering or upper lid component to cover internal lighting elements, prevent the introduction of dust and debris, provide additional structural or aesthetic advantages, and/or for any other purpose.

In some implementations, components and/or elements of the lighting fixture can be mechanically fastened without the use of any adhesive. Other implementations may include the use of adhesive(s). A plurality of lighting fixtures can also be secured together as a modular lighting unit in certain implementations.

One or more implementations of the present disclosure include a polymer-based lighting system. The system can include components disclosed and/or described herein. For example, the system can include a polymer-based frame (e.g., instead of a metal frame). In at least one implementation, the system can include a metal or other base element, a polymer-based frame attached to and extending from the base element, and one/or more design features attached to the polymer-based frame. The system can also include lighting elements, including bulbs, LEDs, sockets, wires, wiring, accessories, etc. The system can also include one or more fasteners, tool, hardware elements, and/or instructions for assembling the lighting fixture. In certain implementations, the lighting system can include components for forming and/or installing a light weight, polymer-based lighting fixture according to implementations disclosed and/or described herein.

Thus, implementations of the present disclosure may provide lighting fixtures that help magnify the aesthetic features of certain materials included therein, while reducing or otherwise de-emphasizing certain un-appealing features thereof. For example, one or more implementations of the present disclosure can include polymer-based lighting fixtures that reduce or eliminate the visibility of underlying hardware or support elements, thus enhancing the illuminated and/or display surfaces thereof. Additionally, one or more implementations can include unique, aesthetically pleasing, polymer-based lighting fixtures that are cost effective to produce, manufacture, ship, and/or display, as well as methods of forming the same. Such lighting fixture can be both light weight and structurally sound.

Furthermore, implementations of the present disclosure allow for so called all-in-one kit manufacturing of lighting fixtures. Likewise, some implementations allow for (large) modular lighting fixtures and/or assemblies thereof to be manufactured, stored, and/or shipped, etc. as a plurality of compatible modules of various shapes, sizes, dimensions, and curvatures, etc. Such modules can be custom-selected for incorporation into a custom-designed lighting fixture or assembly and shipped in manageable and easily handled modules instead of bulky, and often delicate, assembled structures. Thus, manufacturers and assemblers alike may save time and money by using, incorporating, and/or applying the products, apparatus, methods, and systems described herein.

It will be appreciated that various features, members, elements, parts, and/or portions of certain embodiments of the present invention are compatible with and/or can be combined with, included in, and/or incorporated into other embodiments of the present invention. Thus, disclosure a certain features, members, elements, parts, and/or portions relative to a specific embodiment of the present invention should not be construed as limiting application or inclusion of said features, members, elements, parts, and/or portions to the specific embodiment. Rather, it will be appreciated that other embodiments can also include said features, members, elements, parts, and/or portions without necessarily departing from the scope of the present invention.

In addition, the present disclosure may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. A lighting fixture, comprising:
a polymer-based frame element configured to provide a structural component of the lighting fixture, the frame element comprising a first end, an opposing second end, and a body portion extending between said first and second ends;
a frame support element connected to the first end of the frame element; and
a lighting element disposed at least partially between the frame support element and the second end of the frame element such that the frame support element does not produce a shadow on the body portion of the frame element when the lighting element is illuminated.

2. The lighting fixture of claim 1, further comprising one or more design elements attached to an outer surface of the frame element.

3. The lighting fixture of claim 1, further comprising one or more fasteners securing the frame element to the frame support element.

4. The lighting fixture of claim 1, wherein the frame element is comprised of non-opaque material.

5. The lighting fixture of claim 1, wherein the frame element has an at least partially tubular or hollow configuration.

6. The lighting fixture of claim 1, wherein at least a portion of the frame element has a three dimensional shape selected from the group consisting of a whole or partial cube, cuboid, cylinder, sphere, ellipsoid, cone, pyramid, prism, and torus.

7. The lighting fixture of claim 1, wherein the frame element at least partially bounds an inner lighting compartment, the body portion of the frame element at least partially encircling the lighting element such that the lighting element is at least partially disposed within the inner lighting compartment.

8. The lighting fixture of claim 1, wherein at least a portion of the frame element substantially conceals the frame support element from a first vantage point.

9. The lighting fixture of claim 1, wherein the frame support element is comprised of a metal or metal alloy.

10. The lighting fixture of claim 1, wherein the frame support element comprises an outer perimeter, the first end of the frame element extending about the outer perimeter.

11. The lighting fixture of claim 1, wherein the frame support element does not extend to the body portion of the frame element such that the body portion is devoid of the frame support element.

12. The lighting fixture of claim 1, wherein the frame support element comprises one or more suspension elements configured to retain the frame support element in a suspended configuration, the lighting fixture configured to be suspended from a support structure.

13. The lighting fixture of claim 1, wherein the frame element comprises a plurality of body elements, each having a first end connected to the frame support element, the first end of the frame element comprising the respective first ends of the plurality of body elements.

14. The lighting fixture of claim 13, wherein the plurality of body elements further comprise respective second ends opposite the respective first ends thereof.

15. The lighting fixture of claim 14, wherein the respective second ends of the plurality of body elements are connected to a bottom portion of the lighting fixture, the bottom portion forming or being disposed at the second end of the frame element.

16. The lighting fixture of claim 14, wherein the respective second ends of the plurality of body elements are connected to the frame support element opposite the respective first ends of the plurality of body elements;
the first end of the frame element comprising the respective second ends of the plurality of body elements;
each of the plurality of body elements further comprising a body portion disposed between the first and second ends thereof;
the body portion of the frame element comprising a first portion of the respective body portions of the plurality of body elements;
the second end of the frame element comprising a second portion of the respective body portions of the plurality of body elements.

17. The lighting fixture of claim 1, wherein the frame support element comprises a base, the frame element extending upwardly therefrom.

18. A suspended lighting fixture, comprising:
a non-opaque polymeric frame element having an outer display surface and an opposing inner surface at least partially bounding an inner lighting compartment, the frame element providing a structural component of the lighting fixture such that the frame element is configured to be substantially free of an underlying structural component capable of producing a shadow on the outer surface;
a suspension element connected to an upper portion of the frame element;
at least one frame element fastener attaching the upper portion of the frame element to the suspension element;
a lighting element disposed at least partially within the inner compartment of the frame element below the suspension element such that the lighting element does not cast a shadow of the suspension element on a portion of the frame element below the lighting element when the lighting element is illuminated;
one or more design elements attached to the outer display surface of the frame element; and
at least one design element fastener attaching the one or more design elements to the outer display surface of the frame element.

19. A method of providing an illuminated lighting fixture with reduced visibility of an underlying support element, comprising:
a lighting element disposed at least partially within the lighting fixture, the lighting fixture comprising:
a polymer-based frame element having a first end, an opposing second end, and a body portion extending between said first and second ends, the frame element providing a structural component of the lighting fixture; and
a frame support element connected to the first end of the frame element, the lighting element being disposed at least partially between the frame support element and the second end of the frame element such that the frame support element does not produce a shadow on the body portion of the frame element when the lighting element is activated.

20. The method of claim 19, further comprising:
connecting the first end of the frame element to the frame support element, the frame support element comprising an outer perimeter, the first end of the frame element extending about the outer perimeter, the frame element providing a structural component of the lighting fixture, the body portion of the frame element at least partially encircling the lighting element such that the lighting element is at least partially disposed within the frame element;
wherein the frame support element does not extend to the body portion of the frame element such that the body portion is devoid of the frame support element.

21. The method of claim 19, further comprising:
suspending the frame support element from a support structure such that the lighting fixture is suspended from the support structure;
the frame element having an outer display surface and an opposing inner surface at least partially bounding an inner lighting compartment;
a portion of the frame element at least partially concealing the frame support element from below the suspended lighting fixture;
the lighting element being disposed at least partially within the inner lighting compartment below the frame support element such that the lighting element does not cast a shadow of the frame support element on a portion of the inner surface of the frame element below the lighting element when the lighting element is illuminated.

22. The method of claim 19, further comprising:
providing a polymeric substrate in a first configuration; and
thermoforming a polymeric substrate into a second configuration having a three-dimensional structure, thereby forming the frame element.
